(19) United States
(12) Patent Application Publication
(10) Pub. No.: US 2026/0024237 A1
(43) Pub. Date: Jan. 22, 2026

(54) TEXT RENDERING FOR IMAGE GENERATION MODELS

(71) Applicant: ADOBE INC., SAN JOSE, CA (US)

(72) Inventors: Ruiyi Zhang, Palo Alto, CA (US); Jiuxiang Gu, Baltimore, MD (US); Yufan Zhou, San Jose, CA (US); Curtis Michael Wigington, Annandale, VA (US); Tong Yu, Fremont, CA (US); Jianyi Zhang, Durham, NC (US); Tong Sun, San Ramon, CA (US)

(21) Appl. No.: 18/777,186

(22) Filed: Jul. 18, 2024

(51) Int. Cl. G06T 11/00; G06V 10/25

(52) U.S. Cl. CPC G06T 11/00; G06V 10/25

(57) ABSTRACT

A method, apparatus, non-transitory computer readable medium, and system for image processing include obtaining an image generation prompt comprising a text to be generated in a synthetic image, generating a first image feature based on the image generation prompt, where the first image feature represents the text, and generating a synthetic image based on the image generation prompt and the first image feature, where the synthetic image includes the text.

### BACKGROUND

The following relates generally to image processing, and more specifically to image processing using a machine learning model. Image processing refers to the use of a computer to edit an image using an algorithm or a processing network. In some cases, image processing software can be used for various image processing tasks, such as image restoration, image detection, image editing, image compositing, and image generation. For example, image generation includes the use of a machine learning model to generate a synthetic image based on a conditioning. For example, the machine learning model is trained to generate a synthetic image based on a text, a color, a style, or an image.

### SUMMARY

Aspects of the present disclosure provide a method and system for image generation. In one aspect, the system receives a text prompt and generates a synthetic image based on the text prompt. According to some aspects, the system includes a language generation model configured to generate custom prompts based on an input prompt. In some cases, the custom prompts include a text to be displayed in a synthetic image, layout information that describes or depicts a layout of the text to be generated in the synthetic image, and a text description that provides additional information to an image generation model. The system includes a first image generation model trained to generate a text structure image that depicts the layout of the text based on the text and layout description. In one aspect, the first image generation model is trained to generate one or more image features that represent the text. The system includes a second image generation model trained to generate the synthetic image based on the layout information, the text description, and the one or more image features.

A method, apparatus, non-transitory computer readable medium, and system for image processing include obtaining an image generation prompt comprising a text to be generated in a synthetic image, generating, using a first image generation model, a first image feature based on the image generation prompt, where the first image feature represents the text, and generating, using a second image generation model, a synthetic image based on the image generation prompt and the first image feature, where the synthetic image includes the text.

A method, apparatus, non-transitory computer readable medium, and system for image processing include obtaining a training set including an image generation prompt comprising a display text, training, using the training set, a first image generation model to generate a text structure image based on the display text, and training, using the training set, a second image generation model to generate a synthetic image based on the image generation prompt and an output of the first image generation model.

An apparatus and system for image processing include at least one processor, at least one memory storing instructions executable by the at least one processor, a first image generation model comprising parameters stored in the at least one memory and trained to generate a first image feature based on an image generation prompt comprising a text to be generated in a synthetic image, where the first image feature represents the text, and a second image generation model comprising parameters stored in the at least one memory and trained to generate a synthetic image based on the image generation prompt and the first image feature, where the synthetic image includes the text.

### BRIEF DESCRIPTION OF THE DRAWINGS

FIG. 1 shows an example of an image processing system according to aspects of the present disclosure.

FIG. 2 shows an example of a method for generating a synthetic image including a display text according to aspects of the present disclosure.

FIG. 3 shows an example of text-to-image generation according to aspects of the present disclosure.

FIG. 4 shows an example of local text-to-image generation according to aspects of the present disclosure.

FIG. 5 shows an example of a method for generating a synthetic image based on an image generation prompt according to aspects of the present disclosure.

FIG. 6 shows an example of an image processing apparatus according to aspects of the present disclosure.

FIG. 7 shows an example of a machine learning model according to aspects of the present disclosure.

FIG. 8 shows an example of an image generation model according to aspects of the present disclosure.

FIG. 9 shows an example of a U-Net architecture according to aspects of the present disclosure.

FIG. 10 shows an example of a method for generating custom prompts based on the input prompt according to aspects of the present disclosure.

FIG. 11 shows an example of a method for training a machine learning model according to aspects of the present disclosure.

FIG. 12 shows an example of training the first image generation model according to aspects of the present disclosure.

FIG. 13 shows an example of a computing device according to aspects of the present disclosure.

### DETAILED DESCRIPTION

Aspects of the present disclosure relate to image generation using generative machine learning. Some embodiments of the disclosure relate to an image generation system that accurately generates images showing text based on an input prompt. The images can be generated in different document design styles, such as a poster or an invitation. In one aspect, the system includes a first image generation model trained to generate the text to be displayed and a second image generation model trained to generate a synthetic image including the display text along with additional elements. Intermediate features generated by the first image generation model are provided to the second image generation model to ensure that the display text is accurately generated.

According to some embodiments, the system receives the input prompt and generates multiple “custom” prompts based on the text prompt. For example, the custom prompts can include a first prompt that describes text to be displayed in the synthetic image, a second prompt that describes layout information of the text to be generated, and a third prompt that describes content elements. These prompts can be generated from a single input prompt using a language generation model that takes the input prompt as well as instructions for generating the three different custom prompts.

For example, an original prompt could state “Can you help me with a posted for a farm market?” A language model could generate a first prompt (i.e., a text description) that says “an image depicting the text ‘Farm Market’. A second prompt (i.e., a layout description) can be generated that states “a first word on a first line and a second word on a second line that is centered with the first word”. A third prompt (i.e., a content description) could state “a variety of fruits, vegetables, and dairy products are arranged around a central region including text for a farm market. The layout information (i.e., a layout generated based on the second prompt) can be provided to both the first image generation model and the second image generation model.

In some examples, the layout information includes a location (in an x-y coordinate system) of the text. The first image generation model (also referred to as the text rendering module) receives the text and the layout information to generate the display text. The second image generation model (also referred to as the image module) receives the layout information, the text description, and the image features from the first image generation model to generate the synthetic image.

A subfield of image processing relates to text-to-image generation. Text-to-image generation models generate synthetic images based on an input prompt, for example, a text prompt. In some cases, these models are applied in various applications such as image inpainting, video generation, and style transfer. In some cases, these models generate synthetic images along with texts. For example, the graphic genre of these synthetic images may include advertisements, posters, signs, and book covers. However, conventional image generation models are unable to clearly render the text portion of the synthetic image, making the texts virtually unreadable. As a result, the aesthetic value and functional value of the synthetic image decreases.

Conventional image processing systems use several techniques to address this issue. For example, some systems use image-editing tools to directly superimpose texts onto the synthetic image. However, unnatural artifacts are introduced, especially with images having intricate texture or varying lighting conditions in the background scene of the images. Other systems rely on diffusion models to improve text quality. For example, a text encoder can be used to enhance the quality of text renderings. However, this does not provide suitable control over the generation process.

In some cases, image processing systems enhance on the positioning and architecture of the characters/texts within previously generated image. However, this technique is unsuitable when multiple input text bounding boxes are provided, and thus, does not generalize well with complicated inputs. Furthermore, conventional models fall short on recognizing keywords within the text prompt. For example, given a general user prompt (may be a long, abstract, or ambiguous text prompt), the conventional model is unable to identify the text to be generated within the synthetic image.

In some cases, image generation models are trained on datasets including images that include text. As a result, learning the visual appearance and the text structure using a single model may impact the ability of the image generation model to generate images having accurate text to be generated within the images. Additionally, existing datasets are unable to cover all words and the corresponding combinations (e.g., sentences or short phrases), and thus, conventional models are unable to learn the text structure based on the limited data.

Embodiments of the disclosure improve on conventional image generation models by generated more accurate images that include text. This is achieved using a system that includes two image generation models. One of the models is trained specifically to generate text and the other is trained on a more general training set. Features from the first image generation model are provided to the second image generation model to guide the generation of an image that displays the text accurately. In some cases, layout information is also provided to one or more of the image generation models to improve the positioning of the text.

In one aspect, a language generation model is configured to generate custom prompts based on the input prompt. For example, the language generation model accurately extracts a text (sometimes referred to as display text) from the input prompt. For example, the display text is the text to be generated in the synthetic image. In addition, the language generation model generates layout information based on the input prompt. For example, the layout information is used to generate various layouts of the display text within the synthetic image. Additionally, the language generation model generates a text description based on the input prompt. For example, the text description provides additional guidance to the image generation model to guide the image generation process.

According to some aspects, a first image generation model is trained to generate a text structure image based on the display text and the layout information. For example, the first image generation model is trained to generate text images (or text masks) having different fonts, styles, and sizes. In some cases, for example, the location of the generated display text can be modified by a user. Additionally, the first image generation model is trained to generate image features that represent the display text based on the display text and the layout information. The image features are provided to a second image generation model to guide the generation of display text in the synthetic image.

According to some aspects, the second image generation model is trained to generate the synthetic image based on the layout information, the text description, and the image features. For example, the image features generated from the first image generation model are added to the image features of the second image generation model in an element-wise manner. Accordingly, the second image generation model includes accurate information on the display text (and layout) to be generated.

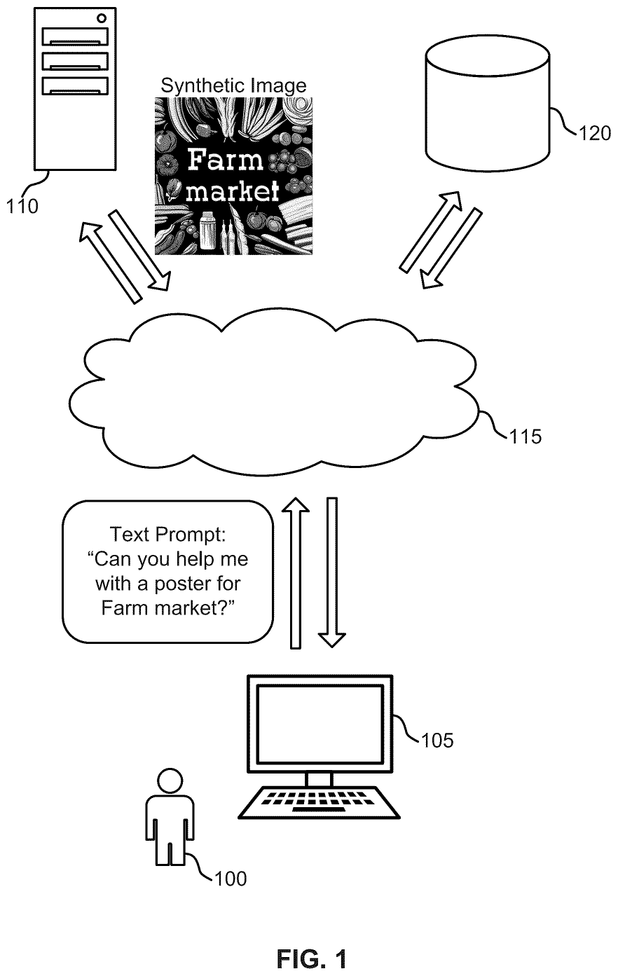

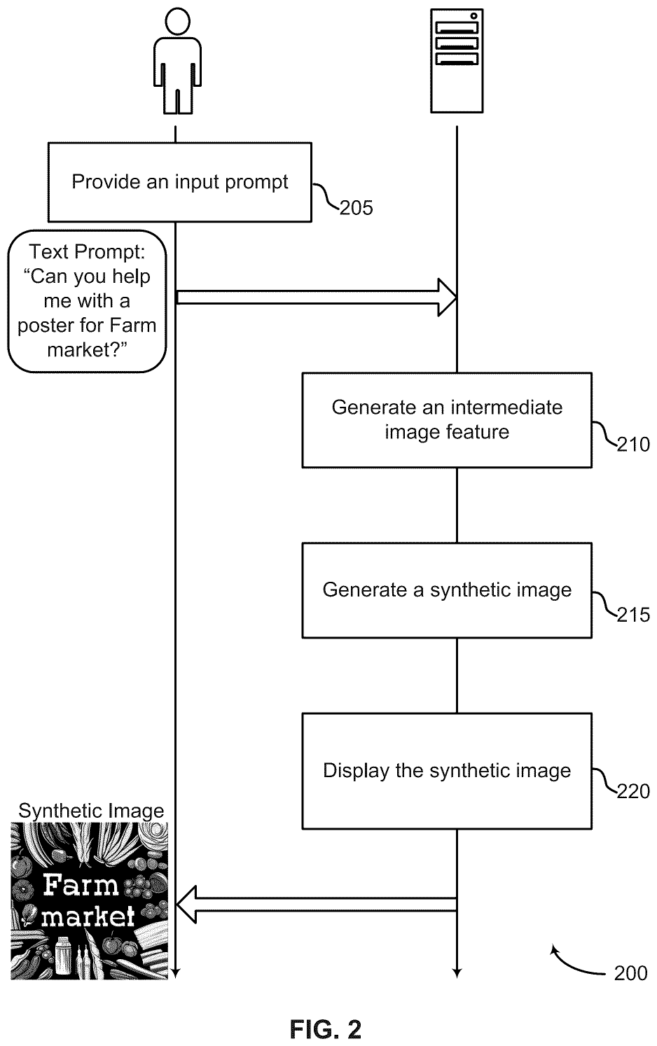

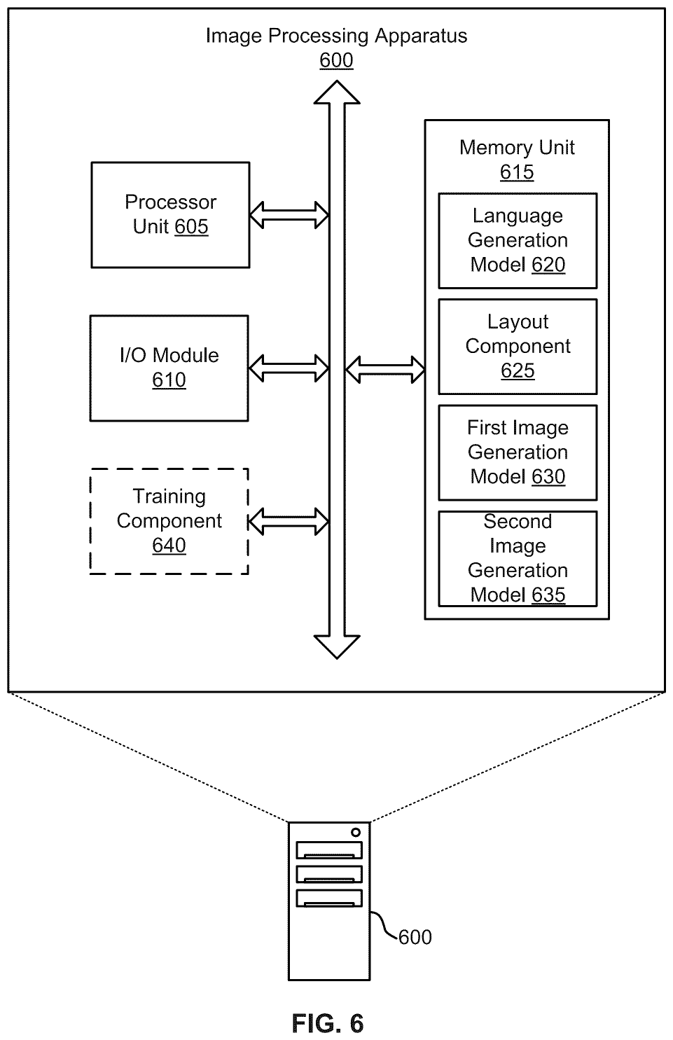

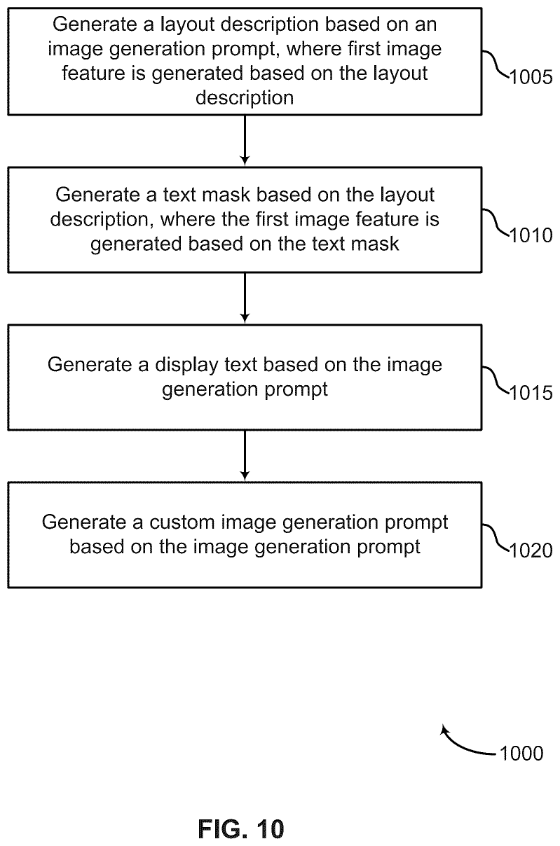

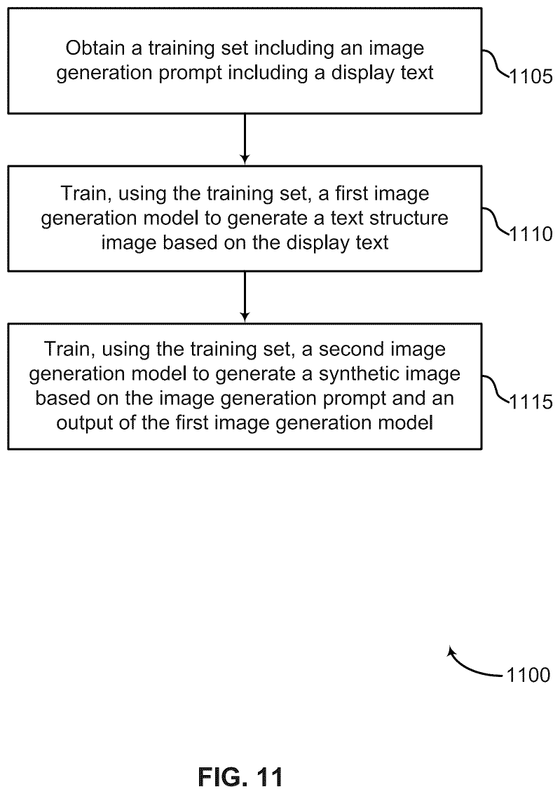

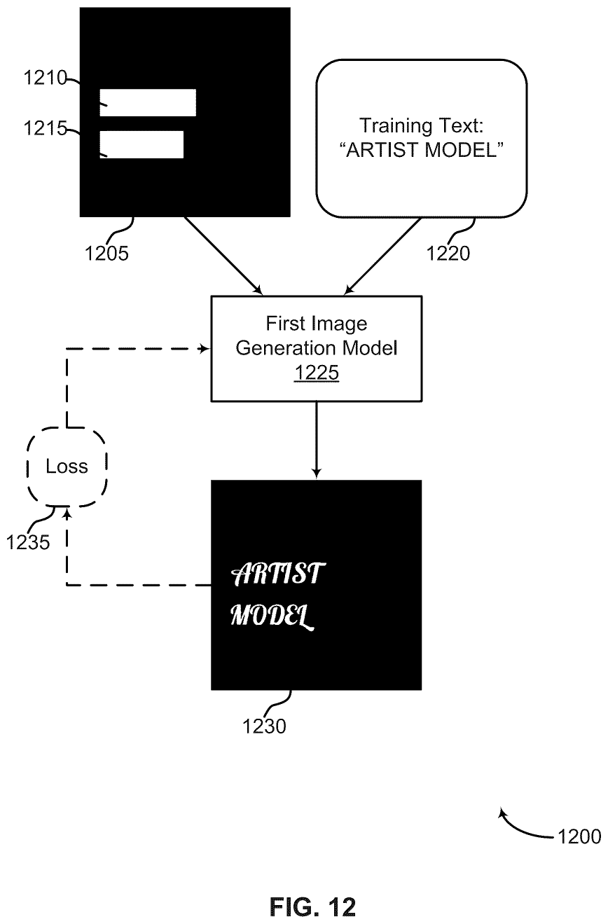

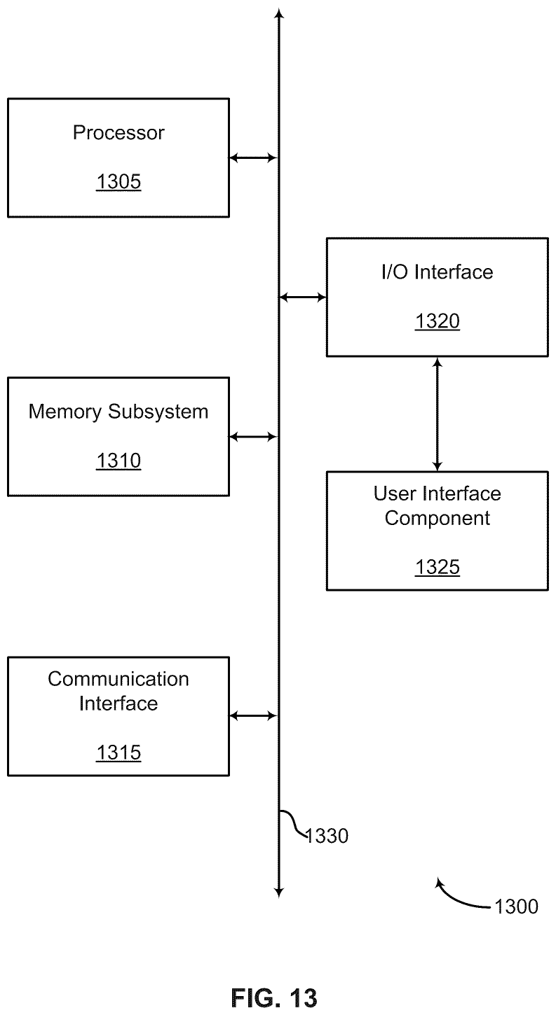

An example system of the inventive concept in image processing is provided with reference to FIGS. 1 and 13. An example application of the inventive concept in image processing is provided with reference to FIGS. 2-4. Details regarding the architecture of an image processing apparatus are provided with reference to FIGS. 6-9. An example of a process for image processing is provided with reference to FIGS. 6 and 10. A description of an example training process is provided with reference to FIGS. 11-12.

Accordingly, the present disclosure provides a system and method that improve on conventional text-to-image generation models by rendering text more accurately and clearly in a synthetic image. For example, the system includes a first image generation model trained to generate text and a second image generation model trained to generate an image including the text. By generating the text and the image using two image generation models, the system is able to accurately and clearly generate the text to be displayed in the synthetic image without compromising the quality of the text or the synthetic image. In addition, by using the two image generation models, the text rendering ability in text-rich image generations is enhanced.

In some aspects, the present disclosure improves the controllability of the text generated within the synthetic image. In one aspect, the system includes a language generation model configured to generate custom prompts based on the text prompt. For example, the language generation model is used to understand, analyze, and evaluate complex text prompts. Accordingly, the image generation can closely align with the intention of the user described by the text prompt.

### Image Generation

In FIGS. 1-5, 10, and 13, a method, apparatus, non-transitory computer readable medium, and system for image generation are described. One or more aspects of the method, apparatus, non-transitory computer readable medium, and system include obtaining an image generation prompt comprising a display text; generating, using a first image generation model, first intermediate image features based on the image generation prompt, wherein the first intermediate image features represent the display text; and generating, using a second image generation model, a synthetic image based on the image generation prompt and the first intermediate image features, wherein the synthetic image includes the display text.

Some examples of the method, apparatus, non-transitory computer readable medium, and system further include generating, using a language generation model, a layout description based on the image generation prompt. In some cases, the first intermediate image features are generated based on the layout description. Some examples of the method, apparatus, non-transitory computer readable medium, and system further include generating a text mask based on the layout description. In some cases, the first intermediate image features are generated based on the text mask.

Some examples of the method, apparatus, non-transitory computer readable medium, and system further include extracting, using a language generation model, the display text based on the image generation prompt. Some examples of the method, apparatus, non-transitory computer readable medium, and system further include generating, using a language generation model, a custom image generation prompt based on the image generation prompt.

Some examples of the method, apparatus, non-transitory computer readable medium, and system further include generating a plurality of layer-specific intermediate image features at a plurality of layers of the first image generation model, respectively. Some examples further include providing the plurality of layer-specific intermediate image features to a plurality of layers of the second image generation model, respectively.

Some examples of the method, apparatus, non-transitory computer readable medium, and system further include generating, using the second image generation model, a second image feature. Some examples further include adding the first image feature and the second image feature element-wise.

Some examples of the method, apparatus, non-transitory computer readable medium, and system further include obtaining a reference image and a bounding box indicating a region of the reference image. In some cases, the synthetic image depicts the reference image with the display text in the region indicated by the bounding box. In some aspects, the image generation prompt indicates a design category of the synthetic image.

In some aspects, the first intermediate image features are generated using a first diffusion process. In some aspects, the synthetic image is generated using a second diffusion process. In some aspects, the first image generation model is trained to generate text structure images. In some aspects, the second image generation model is trained to generate text design images.

FIG. 1 shows an example of an image processing system according to aspects of the present disclosure. The example shown includes user 100, user device 105, image processing apparatus 110, cloud 115, and database 120. Image processing apparatus 110 is an example of, or includes aspects of, the corresponding element described with reference to FIG. 6.

Referring to FIG. 1, user 100 provides a text prompt to image processing apparatus 110 via user device 105 and cloud 115. In some cases, the text prompt may be a general description of the content to be generated in a synthetic image. For example, the text prompt describes “Can you help me with a poster for Farm market?” In some embodiments, image processing apparatus 110 includes a machine learning model that analyzes the text prompt and generates a synthetic image based on the text prompt. For example, image processing apparatus 110 generates the synthetic image (e.g., a representation of a poster) that depicts the text “Farm market” with a variety of fruits around the text on the synthetic image. Image processing apparatus 110 displays the synthetic image to user 100 via user device 105 and cloud 115.

User device 105 may be a personal computer, laptop computer, mainframe computer, palmtop computer, personal assistant, mobile device, or any other suitable processing apparatus. In some examples, user device 105 includes software that incorporates an image processing application. In some examples, the image processing application on user device 105 may include functions of image processing apparatus 110.

A user interface may enable user 100 to interact with user device 105. In some embodiments, the user interface may include an audio device, such as an external speaker system, an external display device such as a display screen, or an input device (e.g., a remote-controlled device interfaced with the user interface directly or through an I/O controller module). In some cases, a user interface may be a graphical user interface (GUI). In some examples, a user interface may be represented in code in which the code is sent to the user device 105 and rendered locally by a browser. The process of using the image processing apparatus 110 is further described with reference to FIG. 2.

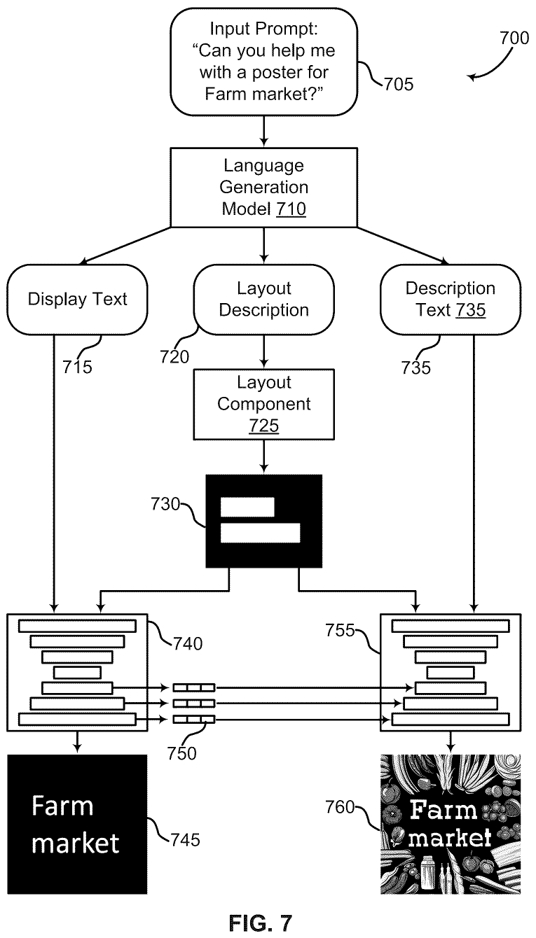

Image processing apparatus 110 is an example of, or includes aspects of, the corresponding element described with reference to FIG. 7. According to some aspects, image processing apparatus 110 includes a computer implemented network comprising a machine learning model, a language generation model, a layout component, a first image generation model, and a second image generation model. Image processing apparatus 110 further includes a processor unit, a memory unit, an I/O module, and a training component. In some embodiments, image processing apparatus 110 further includes a communication interface, user interface components, and a bus as described with reference to FIG. 13. Additionally or alternatively, image processing apparatus 110 communicates with user device 105 and database 120 via cloud 115. Further detail regarding the operation of image processing apparatus 110 is described with reference to FIG. 2.

In some cases, image processing apparatus 110 is implemented on a server. A server provides one or more functions to users linked by way of one or more of the various networks. In some cases, the server includes a single microprocessor board, which includes a microprocessor responsible for controlling aspects of the server. In some cases, a server uses the microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general-purpose computing device, a personal computer, a laptop computer, a mainframe computer, a supercomputer, or any other suitable processing apparatus.

Cloud 115 is a computer network configured to provide on-demand availability of computer system resources, such as data storage and computing power. In some examples, cloud 115 provides resources without active management by the user (e.g., user 100). The term cloud is sometimes used to describe data centers available to many users over the Internet. Some large cloud networks have functions distributed over multiple locations from central servers. A server is designated an edge server if the server has a direct or close connection to a user. In some cases, cloud 115 is limited to a single organization. In other examples, cloud 115 is available to many organizations. In one example, cloud 115 includes a multi-layer communications network comprising multiple edge routers and core routers. In another example, cloud 115 is based on a local collection of switches in a single physical location.

According to some aspects, database 120 stores training data (or training set) including a text prompt comprising a text to be displayed in the synthetic image. Database 120 is an organized collection of data. For example, database 120 stores data in a specified format known as a schema. Database 120 may be structured as a single database, a distributed database, multiple distributed databases, or an emergency backup database. In some cases, a database controller may manage data storage and processing in database 120. In some cases, a user (e.g., user 100) interacts with the database controller. In other cases, the database controller may operate automatically without user interaction.

FIG. 2 shows an example of a method 200 for generating a synthetic image including a display text according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

Referring to FIG. 2, a user (e.g., the user described with reference to FIG. 1) provides a text prompt (or sometimes referred to as the image generation prompt) to the image processing apparatus (e.g., the image processing apparatus described with reference to FIGS. 1 and 6). For example, the text prompt states “Can you help me with a poster for Farm market?” In some aspects, the image processing apparatus includes a language generation model that analyzes the text prompt and generates custom prompts (or reasoning prompts) based on the text prompt. For example, the custom prompts include a display text, a layout description, and a text description (or referred to as a custom image generation prompt). For example, the language generation model extracts the display text that states “Farm market.” For example, the language generation model generates a layout description or layout information that indicates “Farm” to be on the first line and “market to be on the second line in the synthetic image. For example, the language generation model generates text description that includes “hand-drawn, farm market, and poster design.” Further detail on the language generation model is described with reference to FIGS. 7 and 10.

In one aspect, the image processing apparatus includes a first image generation model and a second image generation model. For example, the first image generation model generates image features that represent the text and layout of the synthetic image to be generated based on the text and layout description. The second image generation model generates the synthetic image based on the layout description, the text description, and the image features. The synthetic image depicts a poster that includes the display text “Farm market” located in the center of the synthetic image. In addition, the synthetic image includes flowers surrounding the display text “Farm market.” Further details on the first image generation model and the second image generation model are described with reference to FIGS. 7-9.

At operation 205, the system provides an input prompt. In some cases, the operations of this step refer to, or may be performed by, a user as described with reference to FIG. 1. For example, the user provides a text prompt “Can you help me with a poster for Farm market?” to the image processing apparatus via a user interface provided by the image processing apparatus on a user device (e.g., the user device described with reference to FIG. 1). In some cases, for example, the text prompt may be a short phrase, a long sentence, a compound sentence, a document, or a combination thereof. In some cases, the text prompt may be concise, complex, ambiguous, descriptive, interrogative, or a combination thereof.

In some aspects, the image processing apparatus includes a language generation model that analyzes the text prompt and generates custom prompts based on the text prompt. For example, the custom prompts include a display text, a layout description, and a text description. In some cases, for example, the custom prompts are displayed to the user for modification, selection, feedback, etc. In some cases, the custom prompts are used as input to the first image generation model and the second image generation model. For example, one custom prompt can be generated that describes visual elements consistent with the “farm market” aspect of the original prompt, such as vegetables or dairy products.

In another example, a layout mask or a prompt describing a layout mask can be generated based on, for example, the “poster” design type and other elements of the original prompt that indicate the location of output text within the output image. In another example, a prompt can be generated indicating that the text “Farm Market” is to be included in the output image. In some cases, each of the custom prompts can be generated based on a single original input text provided by a user. In other cases, additional input may be provided such as a selection of a design type (i.e., poster, vector image, invitation, etc.). By generating separate custom prompts (i.e., a display text, a visual description, and a layout prompt), a layout mask can be generated, and a subsequent image generation model can generate a mode accurate output image with coherent visual, layout, and design elements.

At operation 210, the system generates an intermediate image feature. In some cases, the operations of this step refer to, or may be performed by, an image processing apparatus as described with reference to FIGS. 1 and 6. In some cases, the operations of this step refer to, or may be performed by, a first image generation model as described with reference to FIGS. 6 and 7. For example, the first image generation model generates the intermediate image feature based on the display text and the layout description. In some embodiments, the first image generation model generates a plurality of layer-specific intermediate image features at a plurality of layers of the first image generation model. In some cases, each of the plurality of layer-specific intermediate image features represents the display text at the corresponding layer of the first image generation model.

At operation 215, the system generates a synthetic image. In some cases, the operations of this step refer to, or may be performed by, an image processing apparatus as described with reference to FIGS. 1 and 6. In some cases, the operations of this step refer to, or may be performed by, a second image generation model as described with reference to FIGS. 6 and 7. For example, the second image generation model generates the synthetic image based on the layout description, the text description, and the intermediate image feature. In some cases, for example, each of the plurality of layer-specific intermediate image features from the first image generation model is added to the respective layer of the second image generation model as inputs. In some cases, the synthetic image (e.g., a representation of a poster) depicts the text “Farm market” with a variety of fruits around the text on the synthetic image.

At operation 220, the system displays the synthetic image. In some cases, the operations of this step refer to, or may be performed by, an image processing apparatus as described with reference to FIGS. 1 and 6. In some cases, the operations of this step refer to, or may be performed by, a second image generation model as described with reference to FIGS. 6 and 7. For example, the synthetic image is returned and displayed to the user via a user interface provided by the image processing apparatus on the user device.

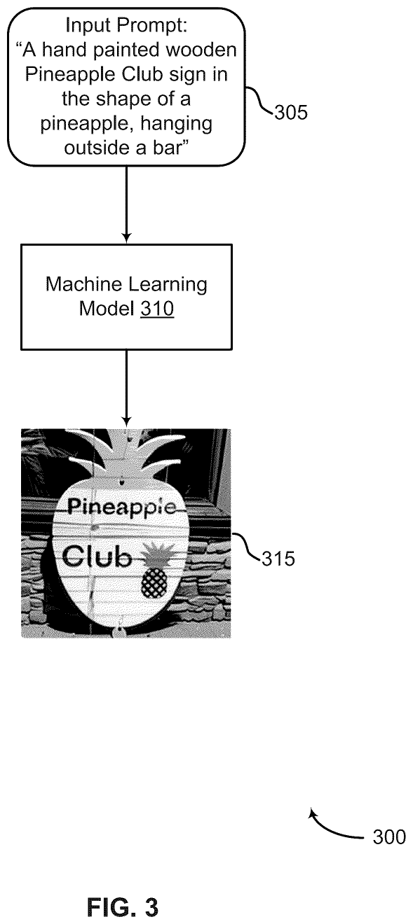

FIG. 3 shows an example of text-to-image generation according to aspects of the present disclosure. The example shown includes image generation system 300, input prompt 305, machine learning model 310, and synthetic image 315. In some cases, the image generation system is included in a user device.

Referring to FIG. 3, machine learning model 310 receives input prompt 305 to generate synthetic image 315. For example, input prompt 305 (or sometimes referred to as an image generation prompt) states “A hand painted wooded Pineapple Club sign in the shape of a pineapple, hanging outside a bar.” In some aspects, machine learning model 310 includes a language generation model that evaluates input prompt 305 and generates a set of reasoning prompts based on input prompt 305. For example, the set of reasoning prompts includes a key term, a layout information, and a text description. For example, the language generation model identifies and extracts the keyword from input prompt 305. The language generation model also generates layout information based on input prompt 305. In some embodiments, a layout component takes the layout information and generates a mask layout based on the layout information. In some cases, the language generation model generates a text description based on input prompt 305. For example, the text description includes terms extracted from input prompt 305 that are helpful to guide the image generation process. In some cases, the text description includes additional terms that are helpful to guide the image generation process. Further detail on the language generation model is described with reference to FIGS. 7 and 10.

In some embodiments, two image generation models are used to generate the synthetic image 315. For example, a first image generation model takes the key term and the layout information to generate a text structure image. The text structure image depicts the text (including the type of font, style, and size) and the location of the text in the synthetic image 315 to be generated. Additionally, the first image generation model generates image features based on the key term and the layout information. The image features are provided to the second image generation model to guide the image generation process. Further detail on the first image generation model is described with reference to FIG. 7.

In some cases, the second image generation model receives the layout information, the text description, and the image feature to generate the synthetic image 315. For example, the image feature from the first image generation model is added to the image feature of the second image generation model at the corresponding convolution layer of the second image generation model. Further detail on the second image generation model is described with reference to FIG. 7.

The synthetic image 315 depicts the key term, includes the design category indicated by input prompt 305, and elements described by input prompt 305. For example, synthetic image 315 depicts a pineapple-shaped wooden sign outside of a bar, and the sign reads “Pineapple Club.”

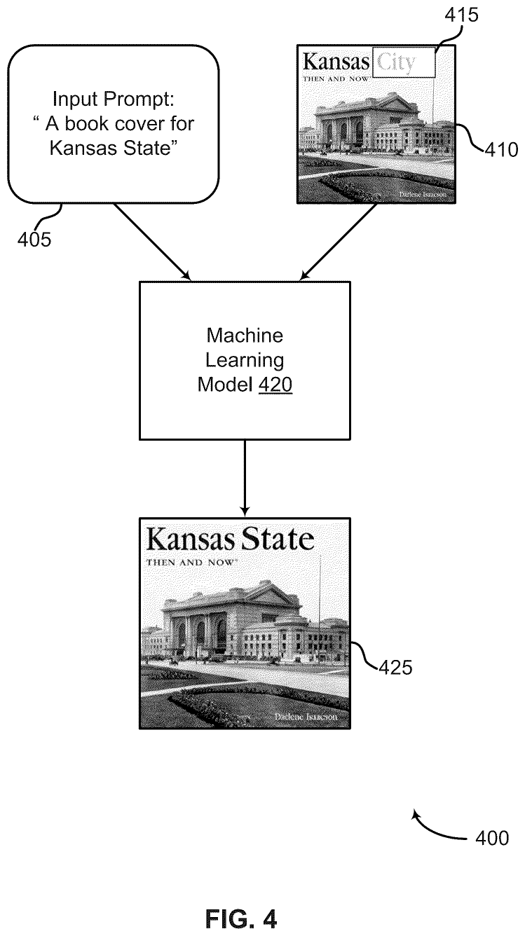

Image generation system 300 is an example of, or includes aspects of, the corresponding element described with reference to FIG. 4. Input prompt 305 is an example of, or includes aspects of, the corresponding element described with reference to FIGS. 4 and 7. Machine learning model 310 is an example of, or includes aspects of, the corresponding element described with reference to FIG. 4. Synthetic image 315 is an example of, or includes aspects of, the corresponding element described with reference to FIGS. 4 and 7.

FIG. 4 shows an example of local text-to-image generation according to aspects of the present disclosure. The example shown includes image generation system 400, input prompt 405, reference image 410, bounding box 415, machine learning model 420, and synthetic image 425.

Referring to FIG. 4, machine learning model 420 receives input prompt 405, reference image 410, and bounding box 415 to generate synthetic image 425. In some cases, bounding box 415 indicates a region of the reference image 410 so that one or more features within the region of reference image 410 indicated by bounding box 415 are modified based on input prompt 405. For example, input prompt 405 states “A book cove for Kansas State.” For example, reference image 410 depicts a book cover with a title that reads “Kansas City.” For example, the bounding box 415 is selected at the region of the book cover that indicates “City.” Machine learning model 420 takes these inputs (e.g., input prompt 405, reference image 410, and bounding box 415) and modifies the text within the bounding box 415 of the reference image 410 from “City” to “State” while preserving the features (such as the background) of the reference image 410.

Image generation system 400 is an example of, or includes aspects of, the corresponding element described with reference to FIG. 3. Input prompt 405 is an example of, or includes aspects of, the corresponding element described with reference to FIGS. 3 and 7. Machine learning model 420 is an example of, or includes aspects of, the corresponding element described with reference to FIG. 3. Synthetic image 425 is an example of, or includes aspects of, the corresponding element described with reference to FIGS. 3 and 7.

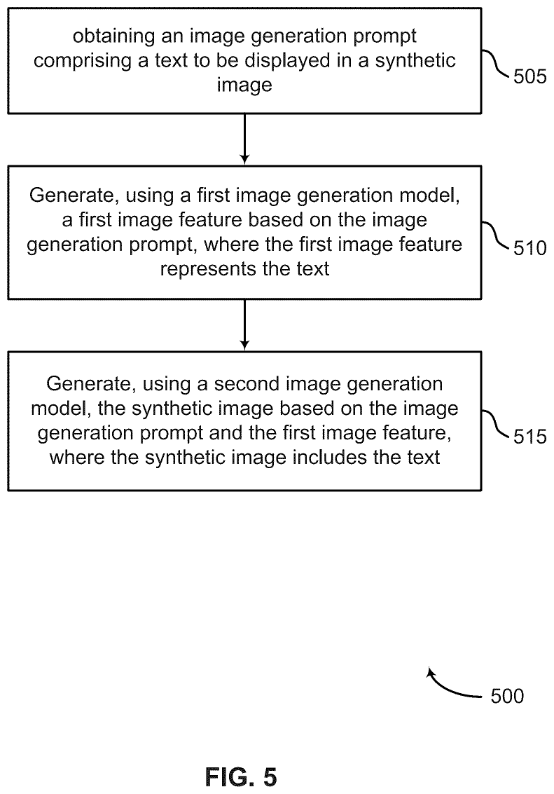

FIG. 5 shows an example of a method 500 for generating a synthetic image based on an image generation prompt according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 505, the system obtains an image generation prompt including a text to be displayed in a synthetic image. In some cases, the operations of this step refer to, or may be performed by, a language generation model as described with reference to FIGS. 6 and 7. In some cases, for example, an image generation prompt is a text prompt or a user inquiry provided by a user. The image generation prompt includes a complex, open-domain user instruction. In some cases, the image generation prompt is provided to a language generation model to generate reasoning prompts.

In some cases, for example, the reasoning prompts include a text (or display text), a layout description, and a custom image generation prompt. For example, the text is extracted from the image generation prompt using the language generation model. For example, the language generation model generates the layout description based on the image generation prompt, where the layout description includes information on the layout of the text to be generated in the synthetic image. For example, the language generation model generates the custom image generation prompt based on the image generation prompt, where the custom image generation prompt includes terms extracted from the image generation prompt that are helpful to guide the image generation process. In some cases, the custom image generation prompt includes additional terms that are helpful to guide the image generation process.

In some cases, the custom image generation prompt includes a design category. For example, the design category includes a graphic genre such as poster, image, vector image, book cover, logo, sign, newspaper, etc. In some cases, the design category includes objects such as a hat, door, book, animal, etc.

At operation 510, the system generates, using a first image generation model, a first image feature based on the image generation prompt, where the first image feature represents the text. In some cases, the operations of this step refer to, or may be performed by, a first image generation model as described with reference to FIGS. 6, 7, and 12. In some cases, for example, the first image generation model generates a plurality of layer-specific image features at a plurality of layers of the first image generation model. The plurality of layer-specific image features is provided to a plurality of layers of the second image generation model, respectively, to guide the image generation process. In one aspect, the image feature includes information on the text to be generated. In some cases, the first image feature includes characteristics or attributes of an image that can be computationally analyzed. For example, an image feature represents aspects of an image such as edges, textures, colors, shapes, or patterns.

In some cases, an image feature may be represented as a vector form in an image embedding space. Vector space provides a framework for representing and manipulating data (in the form of vectors), computing distances between vectors, and transforming input data for complex relationships. The dimensionality of the vector space is determined by the number of features in the feature vector. For example, if each data point has three features (e.g., length, width, and height), the vector space is three-dimensional. In some cases, a joint vector space includes a high-dimensional vector space and a low-dimensional vector space. In some cases, an image embedding is in a high-dimensional vector space and a text embedding is in a low-dimensional vector space.

At operation 515, the system generates, using a second image generation model, a synthetic image based on the image generation prompt and the first image feature, where the synthetic image includes the text. In some cases, the operations of this step refer to, or may be performed by, a second image generation model as described with reference to FIGS. 6 and 7. For example, the second image generation model generates the synthetic image based on the layout description, the custom image generation prompt, and the first image feature.

### System Architecture

In FIGS. 6-9, an apparatus and system for image processing include at least one processor, at least one memory storing instructions executable by the at least one processor, a first image generation model comprising parameters stored in the at least one memory and trained to generate a first image feature based on an image generation prompt comprising a text to be generated in a synthetic image, where the first image feature represents the text, and a second image generation model comprising parameters stored in the at least one memory and trained to generate a synthetic image based on the image generation prompt and the first image feature, where the synthetic image includes the text.

Some examples of the apparatus and system further include a language generation model configured to generate the display text, a layout description, or a custom image generation prompt. Some examples of the apparatus and system further include a layout component configured to generate a layout based on a layout description. In some aspects, the first image generation model comprises a first diffusion model. In some aspects, the second image generation model comprises a second diffusion model.

FIG. 6 shows an example of an image processing apparatus 600 according to aspects of the present disclosure. The example shown includes image processing apparatus 600, processor unit 605, I/O module 610, memory unit 615, and training component 640. In one aspect, memory unit 615 includes language generation model 620, layout component 625, first image generation model 630, and second image generation model 635.

According to some embodiments of the present disclosure, image processing apparatus 600 includes a computer-implemented artificial neural network (ANN). An ANN is a hardware or a software component that includes a number of connected nodes (e.g., artificial neurons), which loosely correspond to the neurons in a human brain. Each connection, or edge, transmits a signal from one node to another (like the physical synapses in a brain). When a node receives a signal, the node processes the signal and then transmits the processed signal to other connected nodes. In some cases, the signals between nodes comprise real numbers, and the output of each node is computed by a function of the sum of its inputs. In some examples, nodes may determine the output using other mathematical algorithms (e.g., selecting the max from the inputs as the output) or any other suitable algorithm for activating the node. Each node and edge is associated with one or more node weights that determine how the signal is processed and transmitted. Image processing apparatus 600 is an example of, or includes aspects of, the corresponding element described with reference to FIG. 1.

Processor unit 605 is an intelligent hardware device, (e.g., a general-purpose processing component, a digital signal processor (DSP), a central processing unit (CPU), a graphics processing unit (GPU), a microcontroller, an application-specific integrated circuit (ASIC), a field programmable gate array (FPGA), a programmable logic device, a discrete gate or transistor logic component, a discrete hardware component, or any combination thereof). In some cases, processor unit 605 is configured to operate a memory array using a memory controller. In other cases, a memory controller is integrated into the processor. In some cases, processor unit 605 is configured to execute computer-readable instructions stored in a memory to perform various functions. In some embodiments, processor unit 605 includes special-purpose components for modem processing, baseband processing, digital signal processing, or transmission processing. Processor unit 605 is an example of, or includes aspects of, the processor described with reference to FIG. 13.

I/O module 610 (e.g., an input/output interface) may include an I/O controller. An I/O controller may manage input and output signals for a device. I/O controller may also manage peripherals not integrated into a device. In some cases, an I/O controller may represent a physical connection or port to an external peripheral. In some cases, an I/O controller may utilize an operating system such as iOS®, ANDROID®, MS-DOS®, MS-WINDOWS®, OS/2®, UNIX®, LINUX®, or another known operating system. In other cases, an I/O controller may represent or interact with a modem, a keyboard, a mouse, a touchscreen, or a similar device. In some cases, an I/O controller may be implemented as part of a processor. In some cases, a user may interact with a device via an I/O controller or via hardware components controlled by an I/O controller.

In some examples, I/O module 610 includes a user interface. A user interface may enable a user to interact with a device. In some embodiments, the user interface may include an audio device, such as an external speaker system, an external display device such as a display screen, or an input device (e.g., a remote control device interfaced with the user interface directly or through an I/O controller module). In some cases, a user interface may be a graphical user interface (GUI). In some examples, a communication interface operates at the boundary between communicating entities and the channel and may also record and process communications. A communication interface is provided herein to enable a processing system coupled to a transceiver (e.g., a transmitter and/or a receiver). In some examples, the transceiver is configured to transmit (or send) and receive signals for a communications device via an antenna. I/O module 610 is an example of, or includes aspects of, the I/O interface described with reference to FIG. 13.

Examples of memory unit 615 include random access memory (RAM), read-only memory (ROM), or a hard disk. Examples of memory unit 615 include solid-state memory and a hard disk drive. In some examples, memory unit 615 is used to store computer-readable, computer-executable software including instructions that, when executed, cause a processor to perform various functions described herein.

In some cases, memory unit 615 includes, among other things, a basic input/output system (BIOS) that controls basic hardware or software operations such as the interaction with peripheral components or devices. In some cases, a memory controller operates memory cells. For example, the memory controller can include a row decoder, column decoder, or both. In some cases, memory cells within memory unit 615 store information in the form of a logical state.

In one aspect, memory unit 615 includes a machine learning model. In one aspect, memory unit 615 includes language generation model 620, layout component 625, first image generation model 630, and second image generation model 635. Memory unit 615 is an example of, or includes aspects of, the memory subsystem described with reference to FIG. 13.

In some cases, a machine learning model is a computational algorithm, model, or system designed to recognize patterns, make predictions, or perform a specific task (for example, image processing) without being explicitly programmed. According to some aspects, the machine learning model is implemented as software stored in memory unit 615 and executable by processor unit 605, as firmware, as one or more hardware circuits, or as a combination thereof.

According to some embodiments of the present disclosure, the machine learning model includes an ANN, which is a hardware or a software component that includes a number of connected nodes (e.g., artificial neurons), which loosely correspond to the neurons in a human brain. Each connection, or edge, transmits a signal from one node to another (like the physical synapses in a brain). When a node receives a signal, the node processes the signal and then transmits the processed signal to other connected nodes. In some cases, the signals between nodes comprise real numbers, and the output of each node is computed by a function of the sum of its inputs. In some examples, nodes may determine the output using other mathematical algorithms (e.g., selecting the max from the inputs as the output) or any other suitable algorithm for activating the node. Each node and edge is associated with one or more node weights that determine how the signal is processed and transmitted.

During the training process, the one or more node weights are adjusted to increase the accuracy of the result (e.g., by minimizing a loss function that corresponds in some way to the difference between the current result and the target result). The weight of an edge increases or decreases the strength of the signal transmitted between nodes. In some cases, nodes have a threshold below which a signal is not transmitted at all. In some examples, the nodes are aggregated into layers. Different layers perform different transformations on the corresponding inputs. The initial layer is known as the input layer and the last layer is known as the output layer. In some cases, signals traverse certain layers multiple times.

According to some embodiments, the machine learning model includes a computer-implemented convolutional neural network (CNN). CNN is a class of neural networks commonly used in computer vision or image classification systems. In some cases, a CNN may enable processing of digital images with minimal pre-processing. A CNN may be characterized by the use of convolutional (or cross-correlational) hidden layers. These layers apply a convolution operation to the input before signaling the result to the next layer. Each convolutional node may process data for a limited field of input (e.g., the receptive field). During a forward pass of the CNN, filters at each layer may be convolved across the input volume, computing the dot product between the filter and the input. During the training process, the filters may be modified so that the filters activate when the filters detect a particular feature within the input.

In one aspect, machine learning model includes machine learning parameters. Machine learning parameters, also known as model parameters or weights, are variables that provide behaviors and characteristics of the machine learning model. Machine learning parameters can be learned or estimated from training data and are used to make predictions or perform tasks based on learned patterns and relationships in the data.

Machine learning parameters are adjusted during a training process to minimize a loss function or maximize a performance metric. The goal of the training process is to find optimal values for the parameters that allow the machine learning model to make accurate predictions or perform well on the given task.

For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the machine learning parameters are used to make predictions on new, unseen data.

According to some embodiments, the machine learning model includes a computer-implemented recurrent neural network (RNN). An RNN is a class of ANN in which connections between nodes form a directed graph along an ordered (e.g., a temporal) sequence. This enables an RNN to model temporally dynamic behavior such as predicting what element should come next in a sequence. Thus, an RNN is suitable for tasks that involve ordered sequences such as text recognition (where words are ordered in a sentence). In some cases, an RNN includes one or more finite impulse recurrent networks (characterized by nodes forming a directed acyclic graph), one or more infinite impulse recurrent networks (characterized by nodes forming a directed cyclic graph), or a combination thereof.

According to some embodiments, the machine learning model includes a transformer (or a transformer model, or a transformer network), where the transformer is a type of neural network model used for natural language processing tasks. A transformer network transforms one sequence into another sequence using an encoder and a decoder. The encoder and decoder include modules that can be stacked on top of each other multiple times. The modules comprise multi-head attention and feed-forward layers. The inputs and outputs (target sentences) are first embedded into an n-dimensional space. Positional encoding of the different words (e.g., give each word/part in a sequence a relative position since the sequence depends on the order of its elements) is added to the embedded representation (n-dimensional vector) of each word. In some examples, a transformer network includes an attention mechanism, where the attention looks at an input sequence and decides at each step which other parts of the sequence are important. The attention mechanism involves a query, keys, and values denoted by Q, K, and V, respectively. Q is a matrix that contains the query (vector representation of one word in the sequence), K are the keys (vector representations of the words in the sequence) and V are the values, which are again the vector representations of the words in the sequence. For the encoder and decoder, multi-head attention modules, V consists of the same word sequence as Q. However, for the attention module that takes into account the encoder and the decoder sequences, V is different from the sequence represented by Q. In some cases, values in V are multiplied and summed with some attention-weights a.

In the machine learning field, an attention mechanism (e.g., implemented in one or more ANNs) is a method of placing differing levels of importance on different elements of an input. Calculating attention may involve three basic steps. First, a similarity between the query and key vectors obtained from the input is computed to generate attention weights. Similarity functions used for this process can include the dot product, splice, detector, and the like. Next, a softmax function is used to normalize the attention weights. Finally, the attention weights are weighed together with the corresponding values. In the context of an attention network, the key and value are vectors or matrices that are used to represent the input data. The key is used to determine which parts of the input the attention mechanism should focus on, while the value is used to represent the actual data being processed.

An attention mechanism is a key component in some ANN architectures, particularly ANNs employed in natural language processing (NLP) and sequence-to-sequence tasks, that allows an ANN to focus on different parts of an input sequence when making predictions or generating output. Some sequence models (such as RNNs) process an input sequence sequentially, maintaining an internal hidden state that captures information from previous steps. However, in some cases, this sequential processing leads to difficulties in capturing long-range dependencies or attending to specific parts of the input sequence.

The attention mechanism addresses these difficulties by enabling an ANN to selectively focus on different parts of an input sequence, assigning varying degrees of importance or attention to each part. The attention mechanism achieves the selective focus by considering the relevance of each input element with respect to the current state of the ANN.

The term “self-attention” refers to a machine learning model in which representations of the input interact with each other to determine attention weights for the input. Self-attention can be distinguished from other attention models because the attention weights are determined at least in part by the input itself.

According to some aspects, language generation model 620 is implemented as software stored in memory unit 615 and executable by processor unit 605, as firmware, as one or more hardware circuits, or as a combination thereof. According to some aspects, language generation model 620 obtains an image generation prompt including a display text. In some examples, language generation model 620 generates a layout description based on the image generation prompt, where the first intermediate image features are generated based on the layout description.

In some examples, language generation model 620 generates the display text based on the image generation prompt. In some examples, language generation model 620 generates a custom image generation prompt based on the image generation prompt. In some aspects, the image generation prompt indicates a design category of the synthetic image. According to some aspects, language generation model 620 is configured to generate the display text, a layout description, or a custom image generation prompt.

According to some aspects, language generation model 620 includes natural language processing (NLP). NLP refers to techniques for using computers to interpret or generate natural language. In some cases, NLP tasks involve assigning annotation data such as grammatical information to words or phrases within a natural language expression. Different classes of machine-learning algorithms have been applied to NLP tasks. Some algorithms, such as decision trees, utilize hard if-then rules. Other systems use neural networks or statistical models that make soft, probabilistic decisions based on attaching real-valued weights to input features. In some cases, these models express the relative probability of multiple answers. Language generation model 620 is an example of, or includes aspects of, the corresponding element described with reference to FIG. 7.

According to some aspects, layout component 625 is implemented as software stored in memory unit 615 and executable by processor unit 605, as firmware, as one or more hardware circuits, or as a combination thereof. According to some aspects, layout component 625 generates a text mask based on the layout description, where the first intermediate image features are generated based on the text mask. According to some aspects, layout component 625 is configured to generate a layout based on a layout description. Layout component 625 is an example of, or includes aspects of, the corresponding element described with reference to FIG. 7.

According to some aspects, first image generation model 630 is implemented as software stored in memory unit 615 and executable by processor unit 605, as firmware, as one or more hardware circuits, or as a combination thereof. According to some aspects, first image generation model 630 generates first intermediate image features based on the image generation prompt, where the first intermediate image features represent the display text.

In some examples, first image generation model 630 generates a set of layer-specific intermediate image features at a set of layers of the first image generation model 630, respectively. In some examples, first image generation model 630 provides the set of layer-specific intermediate image features to a set of layers of the second image generation model 635, respectively.

According to some aspects, first image generation model 630 obtains a text mask indicating a location for the display text, where the text structure image is generated based on the text mask. In some aspects, the first intermediate image features are generated using a first diffusion process. In some aspects, the first image generation model 630 is trained to generate text structure images.

According to some aspects, first image generation model 630 comprises parameters stored in the at least one memory and trained to generate first intermediate image features based on an image generation prompt comprising a display text, where the first intermediate image features represent the display text. In some aspects, the first image generation model 630 includes a first diffusion model. First image generation model 630 is an example of, or includes aspects of, the corresponding element described with reference to FIGS. 7 and 12.

According to some aspects, second image generation model 635 is implemented as software stored in memory unit 615 and executable by processor unit 605, as firmware, as one or more hardware circuits, or as a combination thereof. According to some aspects, second image generation model 635 generates a synthetic image based on the image generation prompt and the first intermediate image features, where the synthetic image includes the display text. In some examples, second image generation model 635 generates second intermediate image features. In some examples, second image generation model 635 adds the first intermediate image features and the second intermediate image features element-wise.

In some examples, second image generation model 635 obtains a reference image and a bounding box indicating a region of the reference image, where the synthetic image depicts the reference image with the display text in the region indicated by the bounding box. In some aspects, the synthetic image is generated using a second diffusion process. In some aspects, the second image generation model 635 is trained to generate text design images.

According to some aspects, second image generation model 635 comprises parameters stored in the at least one memory and trained to generate a synthetic image based on the image generation prompt and the first intermediate image features, wherein the synthetic image includes the display text. In some aspects, the second image generation model 635 includes a second diffusion model. Second image generation model 635 is an example of, or includes aspects of, the corresponding element described with reference to FIG. 7.

According to some aspects, training component 640 is implemented as software stored in memory unit 615 and executable by processor unit 605, as firmware, as one or more hardware circuits, or as a combination thereof. According to some embodiments, training component 640 is implemented as software stored in a memory unit and executable by a processor in the processor unit of a separate computing device, as firmware in the separate computing device, as one or more hardware circuits of the separate computing device, or as a combination thereof. In some examples, training component 640 is part of another apparatus other than image processing apparatus 600 and communicates with the image processing apparatus 600. In some examples, training component 640 is part of image processing apparatus 600.

According to some aspects, training component 640 obtains a training set including an image generation prompt including a display text. In some examples, training component 640 trains, using the training set, a first image generation model 630 to generate a text structure image based on the display text. In some examples, training component 640 trains, using the training set, a second image generation model 635 to generate a synthetic image based on the image generation prompt and an output of the first image generation model 630. In some examples, training component 640 freezes the first image generation model 630 while training the second image generation model 635.

In some examples, training component 640 computes a text diffusion loss. In some examples, training component 640 updates parameters of the first image generation model 630 based on the text diffusion loss. In some examples, training component 640 computes a visual diffusion loss. In some examples, training component 640 updates parameters of the second image generation model 635 based on the visual diffusion loss.

FIG. 7 shows an example of a machine learning model according to aspects of the present disclosure. The example shown includes machine learning system 700, input prompt 705, language generation model 710, display text 715, layout description 720, layout component 725, layout mask 730, description text 735, first image generation model 740, text structure image 745, intermediate image feature 750, second image generation model 755, and synthetic image 760.

Referring to FIG. 7, input prompt 705 is provided to machine learning system 700 to generate synthetic image 760. In some cases, input prompt 705 is referred to as an image generation prompt. For example, input prompt 705 is a user query that states “Can you help me with a poster for Farm market?” In some embodiments, language generation model 710 receives input prompt 705 to generate one or more custom prompts. For example, the custom prompts include display text 715, layout description 720, and description text 735.

In one aspect, language generation model 710 analyzes the texts in input prompt 705 and generates natural language texts in response to the inputs. In one aspect, language generation model 710 is trained on datasets including texts, books, articles, websites, etc. In some cases, language generation model 710 includes a transformer architecture. In some aspects, language generation model 710 is able to perform a variety of language-related tasks such as answering questions, generating text, translating languages, summarizing documents, and/or analyzing texts.

In some embodiments, language generation model 710 generates display text 715, layout description 720, and description text 735 based on input prompt 705. In some cases, for example, language generation model 710 identifies and extracts the display text 715, “Farm market,” from input prompt 705. In one aspect, the extracted text (i.e., display text 715) aligns with the intention of what the user wants to be included in the generated image (e.g., synthetic image 760).

In some cases, for example, language generation model 710 generates a layout description 720 that includes information on how the words in display text 715 are to be arranged in the synthetic image 760 to be generated. For example, language generation model 710 may identify the number of words in display text 715 to generate layout description 720. For example, since display text 715 includes two words, the layout description 720 may be a text statement such as “the first word, ‘Farm’, to be arranged in the middle and the second word, ‘market’, to be arranged under the first word, with Times New Roman and font size 36.” In some embodiment, layout component 725 receives a layout description to generate layout mask 730. In some cases, layout mask 730 is a black-and-white image representing the arrangement of display text 715.

In some cases, language generation model 710 generates description text 735 that includes additional texts to guide the image generation process. In some cases, description text 735 is referred to as a custom image generation prompt. In some cases, description text 735 includes additional text that describes the design category, design style, etc. For example, description text 735 may include “hand drawn, Farm market, poster design”. In some cases, description text 735 includes the design style (e.g., hand drawn), the design category (e.g., poster sign), and the text to be printed (e.g., Farm market) on synthetic image 760.

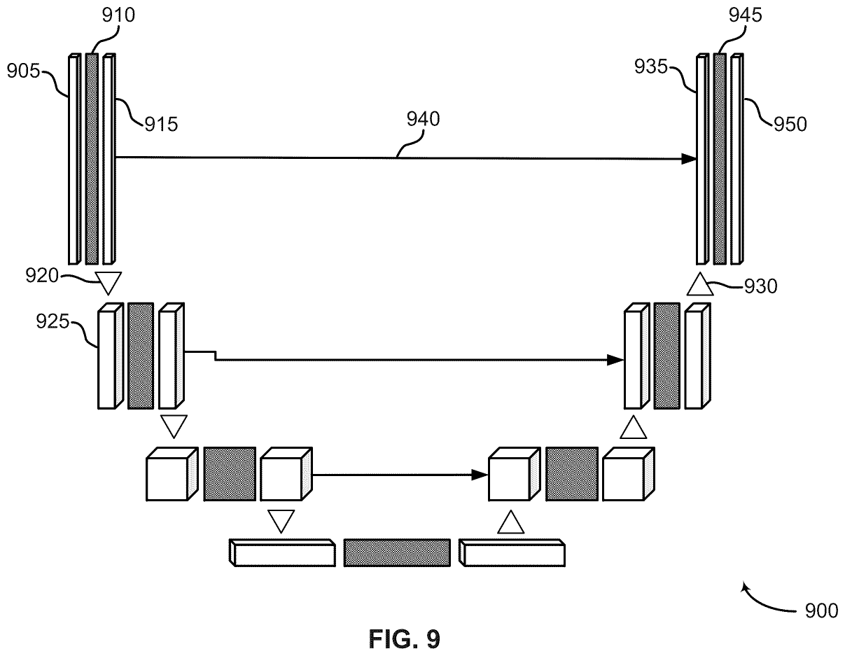

In some embodiments, first image generation model 740 receives display text 715 and layout mask 730 to generate text structure image 745 and intermediate image feature 750. For example, first image generation model 740 is a diffusion model trained to generate text in various styles, fonts, and sizes based on display text 715 and layout mask 730. In some cases, a user (e.g., the user described with reference to FIG. 1) can provide additional input to first image generation model 740 to modify the style, font, and size of the text in text structure image 745. In some embodiments, first image generation model 740 generates intermediate image feature 750 that includes visual information of the text in text structure image 745. In some embodiments, first image generation model 740 generates a plurality of layer-specific intermediate image features at each decoding layer (sometimes referred to as the upsampling layer described with reference to FIG. 9) of first image generation model 740. Then, intermediate image feature 750 is provided to second image generation model 755 as input to guide the image generation process.

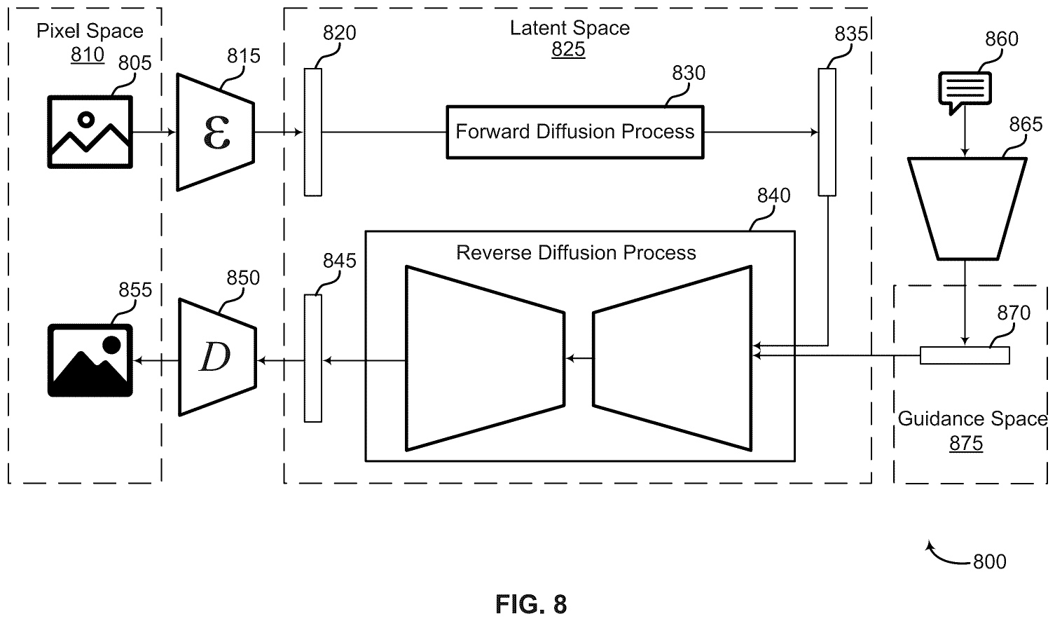

In some embodiments, second image generation model 755 receives layout mask 730, description text 735, and intermediate image feature 750 to generate synthetic image 760. For example, the image generation process of the second image generation model 755 is guided based on layout mask 730 and description text 735 using a diffusion process, for example, described with reference to FIG. 8. Then, during the reverse diffusion process of second image generation model 755, intermediate image feature 750 from first image generation model 740 is added to the image feature in the decoding layer of second image generation model 755. In some embodiments, each of the plurality of layer-specific intermediate image features generated from first image generation model 740 is added to each of a plurality of layer-specific intermediate image features of decoding layers (or upsampling layers) of second image generation model 755, respectively. Accordingly, synthetic image 760 includes the content of text structure image 745, such as high-quality text, text arrangement, text font, and text style.

In some cases, second image generation model 755 generated additional visual features in the background scene to enhance the composition of synthetic image 760. For example, synthetic image 760 includes flowers surrounding the text.

In some embodiments, first image generation model 740 and second image generation model 755 include the same diffusion model. In some embodiments, first image generation model 740 is a smaller diffusion model and has fewer parameters than second image generation model 755. By generating the text and image using first image generation model 740 and second image generation model 755, respectively, text generation and visual generation in a single image can be disentangled. Accordingly, the quality and controllability of the text within the synthetic image 760 are enhanced.

Input prompt 705 is an example of, or includes aspects of, the corresponding element described with reference to FIGS. 3 and 4. Language generation model 710 is an example of, or includes aspects of, the corresponding element described with reference to FIG. 6. Layout component 725 is an example of, or includes aspects of, the corresponding element described with reference to FIG. 6.

First image generation model 740 is an example of, or includes aspects of, the corresponding element described with reference to FIGS. 6 and 12. Second image generation model 755 is an example of, or includes aspects of, the corresponding element described with reference to FIG. 6. Synthetic image 760 is an example of, or includes aspects of, the corresponding element described with reference to FIGS. 3 and 4.

FIG. 8 shows an example of an image generation model according to aspects of the present disclosure. The example shown includes diffusion model 800, original image 805, pixel space 810, image encoder 815, original image feature 820, latent space 825, forward diffusion process 830, noisy feature 835, reverse diffusion process 840, denoised image feature 845, image decoder 850, output image 855, text prompt 860, text encoder 865, guidance feature 870, and guidance space 875.

Diffusion models are a class of generative neural networks that can be trained to generate new data with features similar to features found in training data. In particular, diffusion models can be used to generate novel images. Diffusion models can be used for various image generation tasks including image super-resolution, generation of images with perceptual metrics, conditional generation (e.g., generation based on text guidance, color guidance, style guidance, and image guidance), image inpainting, and image manipulation.

Types of diffusion models include Denoising Diffusion Probabilistic Models (DDPMs) and Denoising Diffusion Implicit Models (DDIMs). In DDPMs, the generative process includes reversing a stochastic Markov diffusion process. DDIMs, on the other hand, use a deterministic process so that the same input results in the same output. Diffusion models may also be characterized by whether the noise is added to the image itself, or to image features generated by an encoder (e.g., latent diffusion).

Diffusion models work by iteratively adding noise to the data during a forward process and then learning to recover the data by denoising the data during a reverse process. For example, during training, diffusion model 800 may take an original image 805 in a pixel space 810 as input and apply an image encoder 815 to convert original image 805 into original image feature 820 in a latent space 825. Then, a forward diffusion process 830 gradually adds noise to the original image feature 820 to obtain noisy feature 835 (also in latent space 825) at various noise levels.

Next, a reverse diffusion process 840 (e.g., a U-Net ANN) gradually removes the noise from the noisy feature 835 at the various noise levels to obtain the denoised image features 845 in latent space 825. In some examples, denoised image feature 845 is compared to the original image feature 820 at each of the various noise levels, and parameters of the reverse diffusion process 840 of the diffusion model are updated based on the comparison. Finally, an image decoder 850 decodes the denoised image feature 845 to obtain an output image 855 in pixel space 810. In some cases, an output image 855 is created at each of the various noise levels. The output image 855 can be compared to the original image 805 to train the reverse diffusion process 840. In some cases, output image 855 refers to the synthetic image (e.g., described with reference to FIGS. 3, 4, 7, and 12).

In some cases, image encoder 815 and image decoder 850 are pre-trained prior to training the reverse diffusion process 840. In some examples, image encoder 815 and image decoder 850 are trained jointly, or the image encoder 815 and image decoder 850 are fine-tuned jointly with the reverse diffusion process 840.

The reverse diffusion process 840 can also be guided based on a text prompt 860, or another guidance prompt, such as an image, a layout, a style, a color, a segmentation map, etc. The text prompt 860 can be encoded using a text encoder 865 (e.g., a multimodal encoder) to obtain guidance features 870 in guidance space 875. The guidance features 870 can be combined with the noisy features 835 at one or more layers of the reverse diffusion process 840 to ensure that the output image 855 includes content described by the text prompt 860. For example, guidance feature 870 can be combined with the noisy feature 835 using a cross-attention block within the reverse diffusion process 840.

Cross-attention, also known as multi-head attention, is an extension of the attention mechanism used in some ANNs, for example, for NLP tasks. In some cases, cross-attention attends to multiple parts of an input sequence simultaneously, capturing interactions and dependencies between different elements. In cross-attention, there are two input sequences: a query sequence and a key-value sequence. The query sequence represents the elements that require attention, while the key-value sequence contains the elements to attend to. In some cases, to compute cross-attention, the cross-attention block transforms (for example, using linear projection) each element in the query sequence into a “query” representation, while the elements in the key-value sequence are transformed into “key” and “value” representations.

The cross-attention block calculates attention scores by measuring the similarity between each query representation and the key representations, where a higher similarity indicates that more attention is given to a key element. An attention score indicates the importance or relevance of each key element to a corresponding query element.

The cross-attention block then normalizes the attention scores to obtain attention weights (for example, using a softmax function), where the attention weights determine how much information from each value element is incorporated into the final attended representation. By attending to different parts of the key-value sequence simultaneously, the cross-attention block captures relationships and dependencies across the input sequences, allowing the machine learning model to understand the context and generate more accurate and contextually relevant outputs.

In some examples, diffusion models are based on a neural network architecture known as a U-Net. The U-Net takes input features having an initial resolution and an initial number of channels, and processes the input features using an initial neural network layer (e.g., a convolutional network layer) to generate intermediate features. The intermediate features are then down-sampled using a down-sampling layer such that down-sampled features have a resolution less than the initial resolution and a number of channels greater than the initial number of channels.

This process is repeated multiple times, and then the process is reversed. For example, the down-sampled features are up-sampled using the up-sampling process to obtain up-sampled features. The up-sampled features can be combined with intermediate features having a same resolution and number of channels via a skip connection. These inputs are processed using a final neural network layer to produce output features. In some cases, the output features have the same resolution as the initial resolution and the same number of channels as the initial number of channels.

In some cases, a U-Net takes additional input features to produce conditionally generated output. For example, the additional input features may include a vector representation of an input prompt. The additional input features can be combined with the intermediate features within the neural network at one or more layers. For example, a cross-attention module can be used to combine the additional input features and the intermediate features.

A diffusion process may also be modified based on conditional guidance. In some cases, a user provides a text prompt (e.g., text prompt 860) describing content to be included in a generated image. In some examples, guidance can be provided in a form other than text, such as via an image, a sketch, a color, a style, or a layout. The system converts text prompt 860 (or other guidance) into a conditional guidance vector or other multi-dimensional representation. For example, text may be converted into a vector or a series of vectors using a transformer model, or a multi-modal encoder. In some cases, the encoder for the conditional guidance is trained independently of the diffusion model.

A noise map is initialized that includes random noise. The noise map may be in a pixel space or a latent space. By initializing an image with random noise, different variations of an image including the content described by the conditional guidance can be generated. Then, the diffusion model 800 generates an image based on the noise map and the conditional guidance vector.

A diffusion process can include both a forward diffusion process 830 for adding noise to an image (e.g., original image 805) or features (e.g., original image feature 820) in a latent space 825 and a reverse diffusion process 840 for denoising the images (or features) to obtain a denoised image (e.g., output image 855). The forward diffusion process 830 can be represented as q(x+ₜ|xₜ₋₁), and the reverse diffusion process 840 can be represented as p(xₜ₋₁|xₜ). In some cases, the forward diffusion process 830 is used during training to generate images with successively greater noise, and a neural network is trained to perform the reverse diffusion process 840 (e.g., to successively remove the noise).

In an example forward diffusion process 830 for a latent diffusion model (e.g., diffusion model 800), the diffusion model 800 maps an observed variable x₀ (either in a pixel space 810 or a latent space 825) intermediate variables x₁, . . . , x_{T} using a Markov chain. The Markov chain gradually adds Gaussian noise to the data to obtain the approximate posterior q(x_{1:T}|x₀) as the latent variables are passed through a neural network such as a U-Net, where x₁, . . . , x_{T} have the same dimensionality as x₀.

The neural network may be trained to perform the reverse diffusion process 840. During the reverse diffusion process 840, the diffusion model 800 begins with noisy data x_{T}, such as a noisy image and denoises the data to obtain the p(xₜ₋₁|xₜ). At each step t−1, the reverse diffusion process 840 takes xₜ, such as the first intermediate image, and t as input. Here, t represents a step in the sequence of transitions associated with different noise levels, The reverse diffusion process 840 outputs xₜ₋₁, such as the second intermediate image iteratively until x_{T} is reverted back to x₀, the original image 805. The reverse diffusion process 840 can be represented as:

$${p}_{θ} ( {x}_{t - 1} \vert {x}_{t} ) := N ( {x}_{t - 1} ; {μ}_{θ} ( {x}_{t} , t ) , {\sum }_{θ} ( {x}_{t} , t ) ) . \qquad ( 1 )$$

The joint probability of a sequence of samples in the Markov chain can be written as a product of conditionals and the marginal probability:

$${x}_{T} : {p}_{θ} ( {x}_{0 : T} ) := p ( {x}_{T} ) {\prod }_{t = 1}^{T} {p}_{θ} ( {x}_{t - 1} \vert {x}_{t} ) , \qquad ( 2 )$$

where p(x_{T})=N(x_{T};0,l) is the pure noise distribution as the reverse diffusion process 840 takes the outcome of the forward diffusion process 830, a sample of pure noise, as input and

$${\prod }_{t = 1}^{T} {p}_{θ} ( {x}_{t - 1} \vert {x}_{t} )$$

represents a sequence of Gaussian transitions corresponding to a sequence of addition of Gaussian noise to the sample.

At interference time, observed data x₀ in a pixel space can be mapped into a latent space 825 as input and a generated data \tilde{x} is mapped back into the pixel space 810 from the latent space 825 as output. In some examples, x₀ represents an original input image with low image quality, latent variables x₁, . . . , x_{T} represent noisy images, and x represents the generated image with high image quality.

A diffusion model 800 may be trained using both a forward diffusion process 830 and a reverse diffusion process 840. In one example, the user initializes an untrained model. Initialization can include defining the architecture of the model and establishing initial values for the model parameters. In some cases, the initialization can include defining hyper-parameters such as the number of layers, the resolution and channels of each layer block, the location of skip connections, and the like.

The system then adds noise to a training image using a forward diffusion process 830 in N stages. In some cases, the forward diffusion process 830 is a fixed process where Gaussian noise is successively added to an image. In latent diffusion models, the Gaussian noise may be successively added to features (e.g., original image features 820) in a latent space 825.

At each stage n, starting with stage N, a reverse diffusion process 840 is used to predict the image or image features at stage n−1. For example, the reverse diffusion process 840 can predict the noise that was added by the forward diffusion process 830, and the predicted noise can be removed from the image to obtain the predicted image. In some cases, an original image 805 is predicted at each stage of the training process.

The training component (e.g., training component described with reference to FIG. 6) compares predicted image (or image features) at stage n−1 to an actual image (or image features), such as the image at stage n−1 or the original input image. For example, given observed data x, the diffusion model 800 may be trained to minimize the variational upper bound of the negative log-likelihood −log p_{θ}(x) of the training data. The training component then updates parameters of the diffusion model 800 based on the comparison. For example, parameters of a U-Net may be updated using gradient descent. Time-dependent parameters of the Gaussian transitions can also be learned.

FIG. 9 shows an example of a U-Net 900 architecture according to aspects of the present disclosure. The example shown includes U-Net 900, input feature 905, initial neural network layer 910, intermediate feature 915, down-sampling layer 920, down-sampled feature 925, up-sampling process 930, up-sampled feature 935, skip connection 940, final neural network layer 945, and output feature 950.

In some examples, diffusion models are based on a neural network architecture known as a U-Net. The U-Net 900 takes input feature 905 having an initial resolution and an initial number of channels, and processes the input feature 905 using an initial neural network layer 910 (e.g., a convolutional network layer) to produce intermediate feature 915. The intermediate feature 915 is then down-sampled using a down-sampling layer 920 such that the down-sampled feature 925 has a resolution less than the initial resolution and a number of channels greater than the initial number of channels.

This process is repeated multiple times, and then the process is reversed. For example, the down-sampled feature 925 is up-sampled using up-sampling process 930 to obtain up-sampled feature 935. The up-sampled feature 935 can be combined with intermediate feature 915 having the same resolution and number of channels via a skip connection 940. These inputs are processed using a final neural network layer 945 to produce output feature 950. In some cases, the output feature 950 has the same resolution as the initial resolution and the same number of channels as the initial number of channels.

In some cases, U-Net 900 takes an additional input feature to produce conditionally generated output. For example, the additional input feature could include a vector representation of an input prompt. The additional input feature can be combined with the intermediate feature 915 within the neural network at one or more layers. For example, a cross-attention module can be used to combine the additional input features and the intermediate feature 915.

During the up-sampling process 930, the up-sampled feature 935 is combined with an additional input feature at each layer of the U-Net 900. For example, the first image generation model (e.g., the first image generation model described with reference to FIG. 7) generates a first intermediate image feature based on the input prompt (e.g., the display text extracted from the input prompt and the layout information generated from the input prompt). In an embodiment, for example, the first intermediate image feature is added to the second intermediate image feature generated by the second image generation model. For example, the first intermediate image feature is added to up-sampled feature 935 at each respected layer of the U-Net 900 of, for example, the second image generation model. In some cases, for example, a cross-attention module is used to combine the first intermediate image feature and the second intermediate image feature (e.g., up-sampled feature 935).

U-Net 900 is an example of, or includes aspects of, the first image generation model described with reference to FIGS. 6, 7, and 12. U-Net 900 is an example of, or includes aspects of, the second image generation model described with reference to FIGS. 6, 7, and 12.

FIG. 10 shows an example of a method 1000 for generating custom prompts based on the input prompt according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

The custom prompts can be specialized prompts for generating certain aspects of an image such as a prompt describing visual elements of the image, a prompt describing a layout of the image, and a prompt describing text to be included in the image as described with reference to FIG. 7. In some cases, each of the custom prompts are generated based on an original input prompt provided by the user. In some cases, additional information such as a selection of an image type (i.e., poster, vector image, etc.) can be provided.

Referring to FIG. 10, a language generation model is used to analyze the texts in the input prompt and to generate natural language texts in response to the input prompt. In some cases, the language generation model includes a transformer architecture. In some aspects, the language generation model is able to perform a variety of language-related tasks such as answering questions, generating text, translating languages, summarizing documents, and/or analyzing texts. In some embodiments, the language generation model generates a display text, a layout description, and a description text based on an input prompt provided by, for example, a user.

In some cases, the language generation model is a pre-trained large language model (LLM) with an open-domain prompt. The language generation model can autonomously identify keywords based on a given text. In one aspect, the language generation model is trained on various open-domain knowledge, and thus, is able to understand user intents and generalize to complicated scenarios (such as complex sentences, ambiguous user queries, commands, and direct text prompts). When given a vague prompt, for example, the language generation model can discern and evaluate which words or text elements to incorporate in the synthetic image.

At operation 1005, the system generates a layout description based on an image generation prompt, where the first intermediate image features are generated based on the layout description. In some cases, the operations of this step refer to, or may be performed by, a language generation model as described with reference to FIGS. 6 and 7. In some cases, for example, the layout description includes information on how the words in the display text are to be arranged in the synthetic image. In some cases, the layout description includes additional information such as the font, style, and size of the words to be generated.

At operation 1010, the system generates a text mask based on the layout description, where the first intermediate image features are generated based on the text mask. In some cases, the operations of this step refer to, or may be performed by, a layout component as described with reference to FIGS. 6 and 7. In some cases, for example, the text mask is a black-and-white image representing the arrangement of the display text. In some cases, the text mask includes a visual representation of the arranged words.

At operation 1015, the system generates a display text based on the image generation prompt. In some cases, the operations of this step refer to, or may be performed by, a language generation model as described with reference to FIGS. 6 and 7. In some cases, for example, the language generation model identifies and extracts the display text from the input prompt. In some cases, the display text aligns with the intention of what the user wants to be included in the synthetic image.

At operation 1020, the system generates a custom image generation prompt based on the image generation prompt. In some cases, the operations of this step refer to, or may be performed by, a language generation model as described with reference to FIGS. 6 and 7. In some cases, the custom image generation prompt includes additional text that describes the design category, design style, etc. based on the image generation prompt. In some cases, the custom image generation prompt is used to guide the image generation process to generate the synthetic image.

### Training and Evaluation

In FIGS. 11-12, a method, apparatus, non-transitory computer readable medium, and system for image processing include obtaining a training set including an image generation prompt comprising a display text, training, using the training set, a first image generation model to generate a text structure image based on the display text, and training, using the training set, a second image generation model to generate a synthetic image based on the image generation prompt and an output of the first image generation model.

Some examples of the method, apparatus, non-transitory computer readable medium, and system further include freezing the first image generation model while training the second image generation model. Some examples of the method, apparatus, non-transitory computer readable medium, and system further include obtaining a text mask indicating a location for the display text. In some cases, the text structure image is generated based on the text mask.

Some examples of the method, apparatus, non-transitory computer readable medium, and system further include computing a text diffusion loss. Some examples further include updating parameters of the first image generation model based on the text diffusion loss. Some examples of the method, apparatus, non-transitory computer readable medium, and system further include computing a visual diffusion loss. Some examples further include updating parameters of the second image generation model based on the visual diffusion loss.

FIG. 11 shows an example of a method 1100 for training a machine learning model according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 1105, the system obtains a training set including an image generation prompt including a display text. In some cases, the operations of this step refer to, or may be performed by, a training component as described with reference to FIG. 6. In some cases, a data preparation component creates a training set from a training dataset. Further detail on creating the training set is described with reference to FIG. 12.

At operation 1110, the system trains, using the training set, a first image generation model to generate a text structure image based on the display text. In some cases, the operations of this step refer to, or may be performed by, a training component as described with reference to FIG. 6. In some cases, the first image generation model is trained to take a bounding box and a text as inputs to generate a black-and-white image depicting the text. Further detail on training the first image generation model is described with reference to FIG. 12.

At operation 1115, the system trains, using the training set, a second image generation model to generate a synthetic image based on the image generation prompt and an output of the first image generation model. In some cases, the operations of this step refer to, or may be performed by, a training component as described with reference to FIG. 6. In some cases, the second image generation model is trained to generate synthetic images based on the image generation prompt and an intermediate image feature generated from the first image generation model. For example, the intermediate features generated from the mid-layer and upsampling layer (described with reference to FIG. 9) of the first image generation model are element-wisely added to the corresponding intermediate output feature of the mid-layer and upsampling layer (described with reference to FIG. 9) of the second image generation model. In some cases, the intermediate features are projected onto the mid-layer and upsampling layer of the second image generation model using a trainable convolutional layer.

During the training of the second image generation model, the first image generation model is frozen. In some cases, the trainable convolutional layer and the second image generation model are fine-tuned. In some cases, the training set used to train the second image generation model includes visual descriptions of the training image. As a result, the second image generation model learns to generate visual content consistent with an input prompt.

In some embodiments, the first image generation model and the second image generation model are initialized from a pre-trained Stable Diffusion checkpoint. In some cases, the first image generation model is pre-trained on the word-level dataset (described with reference to FIG. 12) for 400,000 steps, and fine-tuned on the sentence-level dataset (described with reference to FIG. 12) for 200,000 steps. In some cases, the second image generation model is trained for 250,000 steps. In some embodiments, an optimizer such as an Adam optimizer is used during training with a learning rate of 1e-5 and a weight decay of 1e-2. In some cases, a batch size of 128 is used for training.

FIG. 12 shows an example of training the first image generation model 1225 according to aspects of the present disclosure. The example shown includes training system 1200, input mask 1205, training text 1220, first image generation model 1225, layout image 1230, and text diffusion loss 1235. In one aspect, input mask 1205 includes first bounding box 1210 and second bounding box 1215. First image generation model 1225 is an example of, or includes aspects of, the corresponding element described with reference to FIGS. 6 and 7.

Referring to FIG. 12, first image generation model 1225 is trained to receive input mask 1205 and training text 1220 to generate layout image 1230. For example, training text 1220 includes two words: 1) ARTIST, and 2) MODEL. Then, input mask 1205 includes first bounding box 1210 and second bounding box 1215, where each of the bounding boxes represents the words in training text 1220 is provided to the corresponding bounding box. For example, first bounding box 1210 corresponds to the word ARTIST and second bounding box 1215 corresponds to MODEL. The first image generation model 1225 generates layout image 1230 based on input mask 1205 and training text 1220. In one aspect, layout image 1230 depicts training text 1220 arranged in a way indicated by input mask 1205, where the texts in layout image 1230 have a pre-determined font and style. In some cases, the size of the texts in layout image 1230 is based on the size of bounding boxes in input mask 1205. In some cases, layout image 1230 is referred to as a text structure image. In some embodiments, a text diffusion loss 1235 is calculated based on a ground-truth layout image and layout image 1230 to fine-tune first image generation model 1225.

According to some embodiments, two types of datasets are created to train first image generation model 1225. For example, a word-level dataset and a sentence-level dataset are created from an existing dataset (e.g., Python libraries from Pillow 9.5.0). In one aspect, the word-level dataset comprises 10 million black-and-white images with a single word (e.g., a white word on a black background). To construct the data sample, a data preparation component selects a word from the vocabulary of a text encoder (e.g., a CLIP text encoder), and renders the word with random font and size on a black image. In addition, a ground-truth bounding box for each rendered word is obtained. In some cases, the dataset is further custom during training by moving the word and bounding box to a new location, resulting in an infinite number of effective samples.

In some cases, the sentence-level dataset is created to obtain layout information of how each of the words is to be arranged and combined in a target image (e.g., the synthetic image). In some cases, for example, the sentence-level dataset comprises 50 million black-and-white images from the MARIO-10M dataset. In one aspect, the ground-truth text and layout information are obtained from the MARIO-10M dataset. Then, the data preparation component renders the same text with randomly selected fonts on black and white images having the same layout.

According to some embodiments, first image generation model 1225 is trained in two stages. In some embodiments, first image generation model 1225 is trained in a latent space of a variational autoencoder (VAE). In the first state, first image generation model 1225 is trained to take one bounding box and one target word as inputs to generate a black-and-white image with the word on the image. During the second stage, first image generation model 1225 is fine-tuned on the sentence-level dataset, where first image generation model 1225 takes multiple bounding boxes and multiple words as inputs. For example, [symbol] ={p₁, p₂, . . . , pₙ} represents the number of wors to be generated in the synthetic image. The input mask is an image including the corresponding bounding boxes {m₁, m₂, . . . , mₙ} that indicate the position of each word. During training, the original text-only image and input mask are encoded into latent space features z and m. Then, a time step t˜ Uniform (0, T) and a Gaussian nose E are sampled to obtain a noised feature, zₜ=\sqrt{α̅ₜ}z+\sqrt{1−α̅ₜ}∈, where α̅ₜ is the coefficient of the diffusion process, zₜ and m are concatenated in the feature channel as input to the diffusion model (e.g., first image generation model 1225). Then, first image generation model 1225 is trained with the diffusion loss (e.g., text diffusion loss 1235) between the sampled noise ∈ and the predicted noise Ee using the following loss function:

$${ℒ}_{text} = 𝔼 [ {‖ ϵ - {ϵ}_{θ} ( {z}_{t} , m , 𝒫 , t ‖}_{2}^{2} ] . \qquad ( 3 )$$

According to some embodiments, the learned knowledge from first image generation model 1225 is used to generate high-fidelity images comprising texts. For example, intermediate features generated from first image generation model 1225 are added to image output features of the second image generation model (described with reference to FIG. 11). In some cases, the second image generation model is trained while freezing the first image generation model 1225. For example, intermediate features from first image generation model 1225, represented as

$${\{ {f}_{i} ( {z}_{t} , m , 𝒫 , t ) \}}_{i = 1}^{k} ,$$

are added into the second image generation model, where k represents the number of intermediate features. The second image generation model is trained using the visual diffusion loss using the following loss function:

$${ℒ}_{visual} = 𝔼 [ {‖ ϵ - {ϵ}_{θ} ( {x}_{t} , {\{ {f}_{i} ( {z}_{t} , m , 𝒫 , t ) \}}_{i = 1}^{k} {z}_{t} , m , \overline{𝒫} , t ‖}_{2}^{2} ] , \qquad ( 4 )$$

where [symbol] represents the prompt that includes a visual description of the image, and xₜ=\sqrt{αₜ}x+\sqrt{1−\sqrt{α}ₜ}∈ represents the noised VAE feature of the ground-truth image.

### Computing Device

FIG. 13 shows an example of a computing device 1300 according to aspects of the present disclosure. The example shown includes computing device 1300, processor 1305, memory subsystem 1310, communication interface 1315, I/O interface 1320, user interface component 1325, and channel 1330.

In some embodiments, computing device 1300 is an example of, or includes aspects of, the image processing apparatus described with reference to FIGS. 1 and 6. In some embodiments, computing device 1300 includes processor 1305 that can execute instructions stored in memory subsystem 1310 to obtain an image generation prompt comprising a text to be generated in a synthetic image, generate a first image feature based on the image generation prompt, where the first image feature represents the text, and generate a synthetic image based on the image generation prompt and the first image feature, where the synthetic image includes the text.

According to some embodiments, processor 1305 includes one or more processors. In some cases, processor 1305 is an intelligent hardware device, (e.g., a general-purpose processing component, a digital signal processor (DSP), a central processing unit (CPU), a graphics processing unit (GPU), a microcontroller, an application-specific integrated circuit (ASIC), a field programmable gate array (FPGA), a programmable logic device, a discrete gate or transistor logic component, a discrete hardware component, or a combination thereof. In some cases, processor 1305 is configured to operate a memory array using a memory controller. In other cases, a memory controller is integrated into processor 1305. In some cases, processor 1305 is configured to execute computer-readable instructions stored in a memory to perform various functions. In some embodiments, processor 1305 includes special-purpose components for modem processing, baseband processing, digital signal processing, or transmission processing. Processor 1305 is an example of, or includes aspects of, the processor unit described with reference to FIG. 6.

According to some embodiments, memory subsystem 1310 includes one or more memory devices. Examples of a memory device include random access memory (RAM), read-only memory (ROM), or a hard disk. Examples of memory devices include solid-state memory and a hard disk drive. In some examples, memory is used to store computer-readable, computer-executable software including instructions that, when executed, cause a processor to perform various functions described herein. In some cases, the memory contains, among other things, a basic input/output system (BIOS) that controls basic hardware or software operations such as the interaction with peripheral components or devices. In some cases, a memory controller operates memory cells. For example, the memory controller can include a row decoder, column decoder, or both. In some cases, memory cells within a memory store information in the form of a logical state. Memory subsystem 1310 is an example of, or includes aspects of, the memory unit described with reference to FIG. 6.

According to some embodiments, communication interface 1315 operates at a boundary between communicating entities (such as computing device 1300, one or more user devices, a cloud, and one or more databases) and channel 1330 and can record and process communications. In some cases, communication interface 1315 is provided to enable a processing system coupled to a transceiver (e.g., a transmitter and/or a receiver). In some examples, the transceiver is configured to transmit (or send) and receive signals for a communications device via an antenna. In some cases, a bus is used in communication interface 1315.

According to some embodiments, I/O interface 1320 is controlled by an I/O controller to manage input and output signals for computing device 1300. In some cases, I/O interface 1320 manages peripherals not integrated into computing device 1300. In some cases, I/O interface 1320 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1320 or hardware components controlled by the I/O controller.

According to some embodiments, user interface component 1325 enables a user to interact with computing device 1300. In some cases, user interface component 1325 includes an audio device, such as an external speaker system, an external display device such as a display screen, an input device (e.g., a remote-control device interfaced with a user interface directly or through the I/O controller), or a combination thereof.

The performance of apparatus, systems, and methods of the present disclosure have been evaluated, and results indicate embodiments of the present disclosure have obtained increased performance over existing technology (e.g., conventional image generation models). Example experiments demonstrate that the image processing apparatus based on the present disclosure outperforms conventional image generation models. Details on the example use cases based on embodiments of the present disclosure are described with reference to FIGS. 3-4.

The description and drawings described herein represent example configurations and do not represent all the implementations within the scope of the claims. For example, the operations and steps may be rearranged, combined, or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein but is to be accorded the broadest scope consistent with the principles and novel features disclosed herein.

The described methods may be implemented or performed by devices that include a general-purpose processor, a digital signal processor (DSP), an application-specific integrated circuit (ASIC), a field programmable gate array (FPGA), or other programmable logic device, discrete gate or transistor logic, discrete hardware components, or any combination thereof. A general-purpose processor may be a microprocessor, a conventional processor, a controller, a microcontroller, or a state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
obtaining an image generation prompt comprising a text to be displayed in a synthetic image;
generating, using a first image generation model, a first image feature based on the image generation prompt, wherein the first image feature represents the text; and
generating, using a second image generation model, the synthetic image based on the image generation prompt and the first image feature, wherein the synthetic image includes the text.

2. The method of claim 1, further comprising:
generating, using a language generation model, a layout description based on the image generation prompt, wherein the first image feature is generated based on the layout description.

3. The method of claim 2, further comprising:
generating a text mask based on the layout description, wherein the first image feature is generated based on the text mask.

4. The method of claim 1, wherein obtaining the text comprises:
extracting, using a language generation model, the text based on the image generation prompt.

5. The method of claim 1, further comprising:
generating, using a language generation model, a custom image generation prompt based on the image generation prompt.

6. The method of claim 1, further comprising:
generating a plurality of layer-specific intermediate image features at a plurality of layers of the first image generation model, respectively; and
providing the plurality of layer-specific intermediate image features to a plurality of layers of the second image generation model, respectively.

7. The method of claim 1, wherein generating the synthetic image comprises:
generating, using the second image generation model, a second image feature; and
adding the first image feature and the second image feature element-wise.

8. The method of claim 1, further comprising:
obtaining a reference image and a bounding box indicating a region of the reference image, wherein the synthetic image depicts the reference image with the text in the region indicated by the bounding box.

9. The method of claim 1, wherein:
the first image feature is generated using a first diffusion process; and
the synthetic image is generated using a second diffusion process.

10. The method of claim 1, wherein:
the image generation prompt indicates a design category of the synthetic image.

11. The method of claim 1, wherein:
the first image generation model is trained to generate text structure images; and
the second image generation model is trained to generate text design images.

12. A method comprising:
obtaining a training set including an image generation prompt comprising a text;
training, using the training set, a first image generation model to generate a text structure image based on the text; and
training, using the training set, a second image generation model to generate a synthetic image based on the image generation prompt and an output of the first image generation model.

13. The method of claim 12, further comprising:
freezing the first image generation model while training the second image generation model.

14. The method of claim 12, wherein training the first image generation model comprises:
obtaining a text mask indicating a location for the text, wherein the text structure image is generated based on the text mask.

15. The method of claim 12, wherein training the first image generation model comprises:
computing a text diffusion loss; and
updating parameters of the first image generation model based on the text diffusion loss.

16. The method of claim 12, wherein training the second image generation model comprises:
computing a visual diffusion loss; and
updating parameters of the second image generation model based on the visual diffusion loss.

17. An apparatus comprising:
at least one processor;
at least one memory storing instructions executable by the at least one processor;
a first image generation model comprising parameters stored in the at least one memory and trained to generate a first image feature based on an image generation prompt comprising a text to be displayed in a synthetic image, wherein the first image feature represents the text; and
a second image generation model comprising parameters stored in the at least one memory and trained to generate the synthetic image based on the image generation prompt and the first image feature, wherein the synthetic image includes the text.

18. The apparatus of claim 17, further comprising:
a language generation model configured to generate the text, a layout description, or a custom image generation prompt.

19. The apparatus of claim 17, further comprising:
a layout component configured to generate a layout based on a layout description.

20. The apparatus of claim 17, wherein:
the first image generation model comprises a first diffusion model; and
the second image generation model comprises a second diffusion model.
